(19) United States
(12) Patent Application Publication
(10) Pub. No.: US 2014/0098423 A1
(43) Pub. Date: Apr. 10, 2014

(54) ORNAMENTAL DISPLAY

(71) Applicants: Hiroshi Uchimoto, Kyoto (JP); Mariko Okamoto, Kyoto (JP)

(72) Inventors: Hiroshi Uchimoto, Kyoto (JP); Mariko Okamoto, Kyoto (JP)

(73) Assignee: MINOSHOJI CO.,LTD., Kyoto (JP)

(21) Appl. No.: 14/123,456

(22) PCT Filed: Oct. 25, 2011
(86) PCT No.: PCT/JP2011/074534

§ 371 Date: Dec. 5, 2013

(30) Foreign Application Priority Data
Jun. 2, 2011 (JP) 2011-124260
Aug. 29, 2011 (JP) 2011-185456

(51) Int. Cl. G02B 3/00

(52) U.S. Cl. CPC G02B 3/005
USPC 359/619

(57) ABSTRACT

An ornamental display capable of improving the three-dimensionality of an enlarged virtual image group is provided. In the ornamental display 1, an image element pattern 20 constituted by two-dimensionally arranging a plurality of image elements 21 on a back surface of a transparent material 10 such as an acrylic board using transparent ink, and a light collecting element pattern 30 constituted by two-dimensionally arranging a plurality of convex lens-shaped light collecting elements 31 on the surface of the transparent material 10 are formed. The ornamental display 1 is characterized in that the light collecting element pattern 30 is formed so that the array pitch of the adjacent light collecting elements 31 gradually and continuously changes, thereby displaying an enlarged image of image elements 21 above the transparent material 10 while gradually and continuously changing the height thereof, constituting a three-dimensional enlarged virtual image group Z1 having a curved surface as a whole.

### TECHNICAL FIELD

The present invention relates to an ornamental display for making an enlarged virtual image group appear, and a transparent material having light collecting elements and a light collecting element sheet for use in the ornamental display. More specifically, the present invention relates to an ornamental display for use in ornamentation of various products, such as, e.g., outer panels of amusement machines and/or gaming machines, packaging boxes, advertising bodies, ornaments, display devices, etc.

### TECHNICAL BACKGROUND

Conventionally, in many cases, various products, such as, outer layer panels of amusement machines and/or gaming machines, packaging boxes, advertising bodies, ornaments, and display devices, are provided with ornamentations such as words and/or designs on the surface thereof to draw interests of people. In these ornamentations, a technology to improve the decorativeness by upwardly or downwardly making an enlarged virtual image group such as a design appear from the surface of various products is conventionally known, and disclosed in the below listed Patent Document 1.

In the ornamental display disclosed in this Patent Document 1, a light collecting element pattern in which light collecting elements are arranged two-dimensionally on a surface of a transparent material in a predetermined array pitch with an orientation in the arrangement of the light collecting elements and an image element pattern in which a plurality of image elements are arranged two-dimensionally on a back surface of the transparent material with the same orientation in the arrangement of the image elements as the light collecting element pattern are formed. By forming the light collecting element pattern and the image element pattern so that the array pitch of image elements is different from the array pitch of light collecting elements, a group of enlarged virtual images of the image elements are made to appear above or below the transparent material. Specifically, in the image element pattern, the array pitch of image elements and the array pitch of light collecting elements are differentiated by gradually and continuously changing the array pitch of adjacent image elements so that enlarged virtual images of image elements are made to appear above or below the transparent material while gradually and continuously changing the height and the depth of the enlarged virtual images, to thereby constitute a three-dimensional enlarged virtual image group having a gentle curved surface as a whole.

### PRIOR ART DOCUMENTS

### Patent Document

Patent Document 1: Japanese Patent No. 4413274

### DISCLOSURE OF THE INVENTION

### Problems to be Solved by the Invention

However, in a conventional ornamental display, since the curved surface of the enlarged virtual image group constituted by the enlarged virtual images of the image elements was gentle, the three-dimensionality of the enlarged virtual image group was weak.

Also, the array pitch of the image elements and the change thereof were set based on the predetermined array pitch of the light collecting elements, and the shape of the image element was set based on the array pitch of the image elements and the setting of the changes. Therefore, it was hard to set a complex image element shape, and there were few variations in designs of enlarged virtual image groups constituted from an enlarged virtual image of each image element.

The present invention was made in view of the aforementioned technical background, and aims to provide, initially, an ornamental display capable of improving the three-dimensionality of the enlarged virtual image group, and a transparent material having light collecting elements and a light collecting element sheet used in the ornamental display, and, secondary, an ornamental display capable of easily increasing the variations in the designs of the enlarged virtual image groups, and a transparent material having light collecting elements and a light collecting element sheet used in the ornamental display.

### Means for Solving the Problems

To achieve the aforementioned objects, in an ornamental display according to the present invention, a plurality of convex lens-shaped light collecting elements are arranged two-dimensionally on a front surface of a sheet-like or plate-like transparent material to form a light collecting element pattern, and a plurality of image elements are arranged two-dimensionally on a back surface of the transparent material to form an image element pattern, and the light collecting element pattern and the image element pattern are formed so that an array pitch of the light collecting elements and an array pitch of the image elements differ from each other, whereby an enlarged virtual image of the image element appears above or below the transparent material. In this ornamental display, the light collecting element pattern is formed such that an array pitch of adjacent light collecting elements changes gradually and continuously to make the enlarged virtual image of each image element appear above or below the transparent element while gradually and continuously changing a height or a depth of the enlarged virtual image, which forms a three-dimensional enlarged virtual image group having a curved surface as a whole.

With this, by gradually and continuously changing the array pitch of adjacent light collecting elements, an enlarged virtual image of each image element can be made to appear above or below the transparent material while gradually and continuously changing the height and the depth of the enlarged virtual image of each image element, which enables to constitute a three-dimensional enlarged virtual image group having a curved surface as a whole. Further, since the curvature radius of the enlarged virtual image group decreases and the difference of elevation of the enlarged virtual image group becomes clear, the three-dimensionality of the enlarged virtual image group can be improved. Also, since there will be no need to set a change of the array pitch of image elements and it becomes easier to set complex shapes for image elements, variations in designs of enlarged virtual image groups can be easily increased.

Also, it is preferable that the light collecting element pattern is formed so that the array pitch of the adjacent light collecting elements gradually and continuously changes in a range of 0.3% or less along an array direction of the light collecting elements. With this, since the height and the depth of the enlarged virtual images of image elements can be gradually and continuously changed more assuredly, the curved surface of the enlarged virtual image group can be made smooth.

Also, it is preferable that the light collecting element pattern is formed so that the array pitch of the adjacent light collecting elements gradually and continuously changes in a range of 0.3% or less along an array direction of the light collecting elements. With this, the shape of the enlarged virtual image of the image element can be changed by changing the shape of the light collecting element without changing the shape of the image element.

Furthermore, it is preferable that the light collecting element pattern is formed so that a diameter of each light collecting element in an array direction changes so as to decrease, especially in a range of 0.3% or less, along an array direction of the light collecting elements. With this, since the enlarged virtual image of the image element become smaller in the array direction together with the difference of elevation of the enlarged virtual image of the image element, the curved surface of the enlarged virtual image group can be shown in a state close to an actual three-dimensional object.

Also, it is preferable that the light collecting element pattern is formed so that a shape of each light collecting element changes gradually and continuously from a circular shape to an oval shape smaller in diameter in the array direction along the array direction of the light collecting elements. With this, the curved surface of the enlarged virtual image group can be made to be in a state close to an actual three-dimensional object by an easy setting of the shape of the light collecting element to change from a circular shape to an oval shape.

Furthermore, the light collecting element pattern can be formed so that the array direction of adjacent light collecting elements turns gradually and continuously every light collecting element. In this case, since the enlarged virtual images of the image elements are made to appear while turning, an enlarged virtual image group having a skewed curved surface as a whole can be constituted.

The light collecting element pattern can be formed so that the array direction of adjacent light collecting elements turns gradually and continuously every light collecting element in a range of −0.3 degrees to +0.3 degrees. In this case, since the enlarged virtual image of the image element appears while pivoting with a small angle, the skewness seen in actual three-dimensional objects can be expressed on the curved surface of the enlarged virtual image group.

Also, it is preferable that a second light collecting element pattern is provided outside of the light collecting element pattern so that an enlarged virtual image group of the light collecting element pattern appears above an enlarged virtual image group appeared by the second light collecting element pattern. With this, since a difference of elevation can be generated between the enlarged virtual image group by the light collecting element pattern and the enlarged virtual image group by the second light collecting element pattern, a more perspective, three-dimensional enlarged virtual image group in a prominent state can be constituted.

Furthermore, the ornamental display according to the present invention is provided with a sheet or plate-like transparent material having light collecting elements in which a plurality of convex lens-shaped light collecting elements are arranged two-dimensionally on a front surface of the transparent material to form a light collecting element pattern, and an image element sheet on which a plurality of image elements are arranged two-dimensionally to form an image element pattern, wherein the image element sheet is adhered to a back surface of the transparent material having the light collecting elements. The light collecting element pattern and the image element pattern are formed so that an array pitch of the light collecting elements and an array pitch of the image elements differ from each other, and the light collecting element pattern is formed such that an array pitch of adjacent light collecting elements changes gradually and continuously to make the enlarged virtual image of each image element appear above or below the transparent element having the light collecting elements while gradually and continuously changing a height or a depth of the enlarged virtual image of each image element, which forms a three-dimensional enlarged virtual image group having a curved surface as a whole. With this, by separately producing the transparent material having light collecting elements and the image element sheet and adhering the image element sheet to the back surface of the transparent material having light collecting elements, a separator-type ornamental display can be constituted.

A transparent material having light collecting elements according to the present invention is used for the ornamental display as recited in claim 10, and a plurality of convex lens-shaped light collecting elements are arranged two-dimensionally on a front surface of the transparent material to form a light collecting element pattern. When an image element sheet in which a plurality of image elements are arranged two-dimensionally to form an image element pattern is adhered to a back surface of the transparent material, the light collecting element pattern and the image element pattern are formed so that an array pitch of the light collecting elements and an array pitch of the image elements differ from each other, and the light collecting element pattern is formed such that an array pitch of adjacent light collecting elements changes gradually and continuously to make the enlarged virtual image of each image element appear above or below the transparent element while gradually and continuously changing a height or a depth of the enlarged virtual image, which forms a three-dimensional enlarged virtual image group having a curved surface as a whole. With this, by producing the transparent material having light collecting elements separately from the image element sheet, and adhering the image element sheet to the back surface of the transparent material having light collecting elements, a separator-type ornamental display can be constituted.

An ornamental display according to the present invention is provided with a sheet-like or plate-like transparent material, a light collecting element sheet adhered to a front surface of the transparent material, in which a plurality of convex lens-shaped light collecting elements are arranged two-dimensionally to form a light collecting element pattern, and an image element sheet adhered to a back surface of the transparent material, in which a plurality of image elements are arranged two-dimensionally to form an image element pattern. The light collecting element pattern and the image element pattern are formed so that an array pitch of the light collecting elements and an array pitch of the image elements differ from each other, whereby an enlarged virtual image of the image element appears above or below the transparent material, wherein the light collecting element pattern is formed such that an array pitch of adjacent light collecting elements changes gradually and continuously to make the enlarged virtual image of each image element appear above or below the transparent element while gradually and continuously changing a height or a depth of the enlarged virtual image, which forms a three-dimensional enlarged virtual image group having a curved surface as a whole. With this, by separately producing the light collecting element sheet and the image element sheet, adhering the light collecting element sheet to the surface of the transparent material, and adhering the image element sheet to the back surface of the transparent material, a separator-type ornamental display can be constituted.

An image element sheet according to the present invention is used for the ornamental display as recited in claim 12. A plurality of convex lens-shaped light collecting elements are arranged two-dimensionally on a front surface of the sheet to form a light collecting element pattern. When a sheet or plate-like transparent material is adhered to a back surface of the light collecting element sheet, and an image element sheet in which a plurality of image elements are arranged two-dimensionally to form an image element pattern is adhered to an opposite surface side of the light collecting element sheet, the light collecting element pattern and the image element pattern are formed so that an array pitch of the light collecting elements and an array pitch of the image elements differ from each other, and the light collecting element pattern is formed such that an array pitch of adjacent light collecting elements changes gradually and continuously to make the enlarged virtual image of each image element appear above or below the transparent element while gradually and continuously changing a height or a depth of the enlarged virtual image, which forms a three-dimensional enlarged virtual image group having a curved surface as a whole. With this, by separately producing the light collecting element sheet and the image element sheet, adhering the light collecting element sheet to the surface of the transparent material, and adhering the image element sheet to the back surface of the transparent material, a separator-type ornamental display can be constituted.

An ornamental display according to the present invention is provided with a sheet or plate-like transparent material having light collecting elements, wherein a plurality of convex lens-shaped light collecting elements are arranged two-dimensionally on a front surface of the transparent material to form a light collecting element pattern, and a sheet or plate-like transparent material having image elements, wherein a plurality of image elements are arranged two-dimensionally on a front surface of the transparent material to form an image element pattern. The transparent material having light collecting elements and the transparent material having image elements are adhered to each other on their back surfaces. The light collecting element pattern and the image element pattern are formed so that an array pitch of the light collecting elements and an array pitch of the image elements differ from each other, whereby an enlarged virtual image of the image element appears above or below the transparent material, and the light collecting element pattern is formed such that an array pitch of adjacent light collecting elements changes gradually and continuously to make the enlarged virtual image of each image element appear above or below the transparent element while gradually and continuously changing a height or a depth of the enlarged virtual image, which forms a three-dimensional enlarged virtual image group having a curved surface as a whole. With this, by separately producing the light collecting element sheet and the image element sheet, and adhering the light collecting element sheet and the image element sheet to each other on their back surfaces, a separator-type ornamental display can be constituted.

An ornamental display according to the present invention is provided with a sheet or plate-like transparent material, wherein a plurality of convex lens-shaped light collecting elements are arranged two-dimensionally on a part of a front surface of the transparent material to form a light collecting element pattern, and a plurality of image elements are arranged two-dimensionally on other part of the same front surface to form an image element pattern, and the transparent material is folded between the light collecting element pattern and the image element pattern in a manner such that the light collecting element pattern and the image element pattern are positioned outside and back surfaces of the transparent material facing each other are adhered, wherein the light collecting element pattern and the image element pattern are formed so that an array pitch of the light collecting elements and an array pitch of the image elements differ from each other, wherein the light collecting element pattern is formed such that an array pitch of adjacent light collecting elements changes gradually and continuously to make the enlarged virtual image of each image element appear above or below the transparent element while gradually and continuously changing a height or a depth of the enlarged virtual image, which forms a three-dimensional enlarged virtual image group having a curved surface as a whole. With this, by forming the light collecting element pattern and the image element pattern on the same surface of one transparent material, and folding the transparent material between the light collecting element pattern and the image element pattern in a state in which the light collecting element pattern and the image element pattern are positioned outside, and adhering the facing back surfaces of the transparent material, a folding-type ornamental display can be constituted.

### Effect of the Invention

According to the present invention, by gradually and continuously changing the array pitch of adjacent light collecting elements, an enlarged virtual image of the image element can be made to appear above or below the transparent material while changing the height and the depth thereof to thereby constitute a three-dimensional enlarged virtual image group having a curved surface as a whole.

Also, in comparison to a conventional ornamental display in which the array pitch of the image element pattern is changed, the curvature radius in the enlarged virtual image group becomes smaller and the difference of elevation of the enlarged virtual image group becomes clear, which in turn can improve the three-dimensionality of the enlarged virtual image group.

Further, since there will be no need to set the change in the array pitch of the image elements and it thereby becomes easy to set complex shapes of image elements, the variation of enlarged virtual image group designs can be increased. That is, in the conventional method, since the array pitch, the diameter, and the array direction of the image elements were changed, if the shapes of the image elements were complex, there were many anchor points for setting the shapes of the image elements at the time of drawing them by computer software and there were cases that computer processing became impossible. However, in the present invention, since not the array pitch of the image elements but the array pitch of the light collecting elements are changed, complex shapes of image elements (image element designs) can be dealt with, and the variations of the enlarged virtual image group designs can be easily increased.

Furthermore, according to the separator-type ornamental display as recited in claims 10 to 14, since the light collecting element sheet, the image element sheet, the transparent material having light collecting elements, and the transparent material having image elements can be separately produced. Therefore, by selectively combining them, ornamental displays having various variations can be easily constituted. Specifically, in the present invention, the array pitch of the image elements of the image element pattern is uniform, and therefore an image element sheet and a transparent material having image elements can be produced by persons not skilled in the art. Thus, it is possible to easily constitute an ornamental display by arbitrarily combining the produced material with a light collecting element sheet and a transparent material having light collecting elements produced by a person skilled in the art, for example.

Also, according to the folding-type ornamental display as recited in claim 15, since it is enough to form a light collecting element pattern and an image element pattern on one of the surfaces of a transparent material, a light collecting element pattern and an image element pattern can be formed simultaneously or sequentially on a production line, which enables to constitute an ornamental display quickly.

According to the aforementioned ornamental displays, it is possible to strongly drawn people's attention and improve their buying intentions by being used as ornamentations of various products.

### BRIEF DESCRIPTION OF THE DRAWINGS

FIG. 1 is an exploded view showing an ornamental display according to a first embodiment of the present invention.

FIG. 2 is a schematic cross-sectional view showing the ornamental display of FIG. 1 and a view showing the position where an enlarged virtual image group appears.

FIG. 3 is a schematic view showing the relationship between light collecting elements and image elements of the ornamental display of FIG. 1.

FIG. 4 is a schematic cross-sectional view showing an ornamental display according to a second embodiment and the position where an enlarged virtual image group appears.

FIG. 5 is a schematic view showing the relationship between light collecting elements and image elements of the ornamental display of FIG. 4.

FIG. 6 is a schematic plan view showing a light collecting element pattern of an ornamental display according to a third embodiment.

FIG. 7 is a schematic cross-sectional view of an ornamental display of FIG. 6 and the position where an enlarged virtual image group appears.

FIG. 8 is a plan view showing an enlarged virtual image group of the ornamental display of FIG. 6.

FIG. 9 is a schematic plan view of a light collecting element pattern of the ornamental display according to a fourth embodiment.

FIG. 10 is a plan view showing an enlarged virtual image group of the ornamental display of FIG. 9.

FIG. 11 is a schematic plan view of a light collecting element pattern of an ornamental display according to a fifth embodiment.

FIG. 12 is a schematic cross-sectional view showing an ornamental display of FIG. 11 and the position where enlarged virtual image groups appear.

FIG. 13 is a plan view of enlarged virtual image groups of the ornamental display of FIG. 11.

FIG. 14 is a plan view showing an enlarged virtual image group of an ornamental display according to a sixth embodiment.

FIG. 15 is a schematic cross-sectional view showing an ornamental display according to a seventh embodiment and the position where an enlarged virtual image group appears.

FIG. 16(a) is an enlarged view showing a schematic cross-section of an ornamental display according to the seventh embodiment and FIG. 16(b) is an enlarged view showing a schematic cross-section of another example of an ornamental display according to the seventh embodiment.

FIG. 17 is an enlarged view showing a schematic cross-section of an ornamental display according to a first modified example of the seventh embodiment.

FIG. 18 is an enlarged view showing a schematic cross-section of an ornamental display according to a first modified example of the seventh embodiment.

FIG. 19 is a schematic cross-sectional view showing an ornamental display according to an eighth embodiment and the position where an enlarged virtual image group appears.

FIG. 20(a) is a view showing an ornamental display according to an eighth embodiment in a state before folding a transparent material, and FIG. 20(b) is a view showing in a state in which the transparent material is folded and adhered.

### EMBODIMENTS FOR CARRYING OUT THE INVENTION

Next, embodiments of an ornamental display according to the present invention will be explained. In the following explanation, the size and the array pitch of image elements and light collecting elements shown in the drawings are largely illustrated for emphasis for the convenience of explanation. In actuality, many numbers of extremely small image elements and light collecting elements are arranged.

### First Embodiment

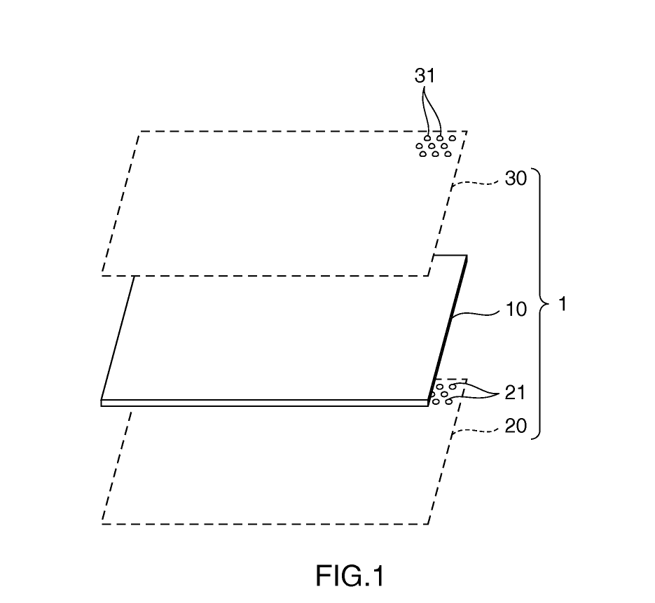

A first embodiment of an ornamental display 1 according to the present invention will be explained with reference to FIGS. 1 to 3.

The ornamental display according to this embodiment is, as shown in FIG. 1, constituted by a plate-like transparent material 10 such as an acrylic board, an image element pattern 20 in which a plurality of image elements 21 of colored or clear or non-clear ink are arranged two-dimensionally on the back surface of the transparent material 10, and a light collecting element pattern 30 in which a plurality of convex lens-shaped light collecting elements 31 of colored or non-colored transparent ink are arranged two-dimensionally on the front surface of the transparent material 10. Both the image element pattern 20 and the light collecting element pattern 30 are formed on the back and front surfaces of the transparent material 10 by printing.

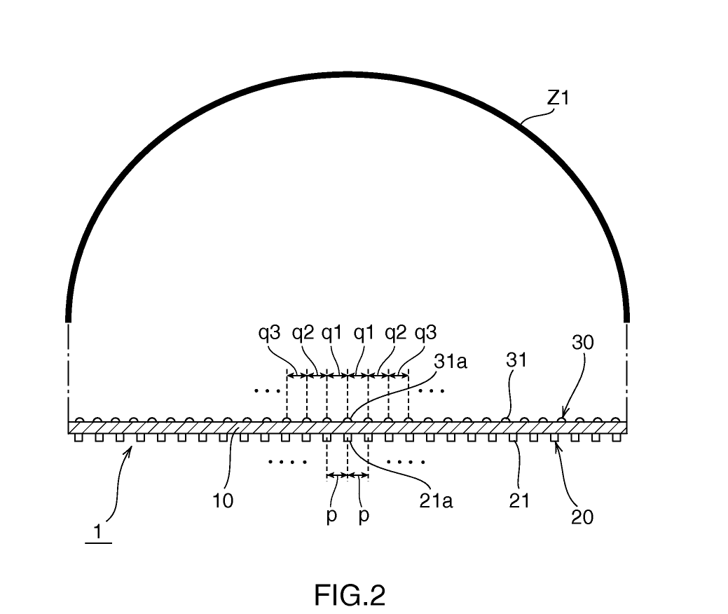

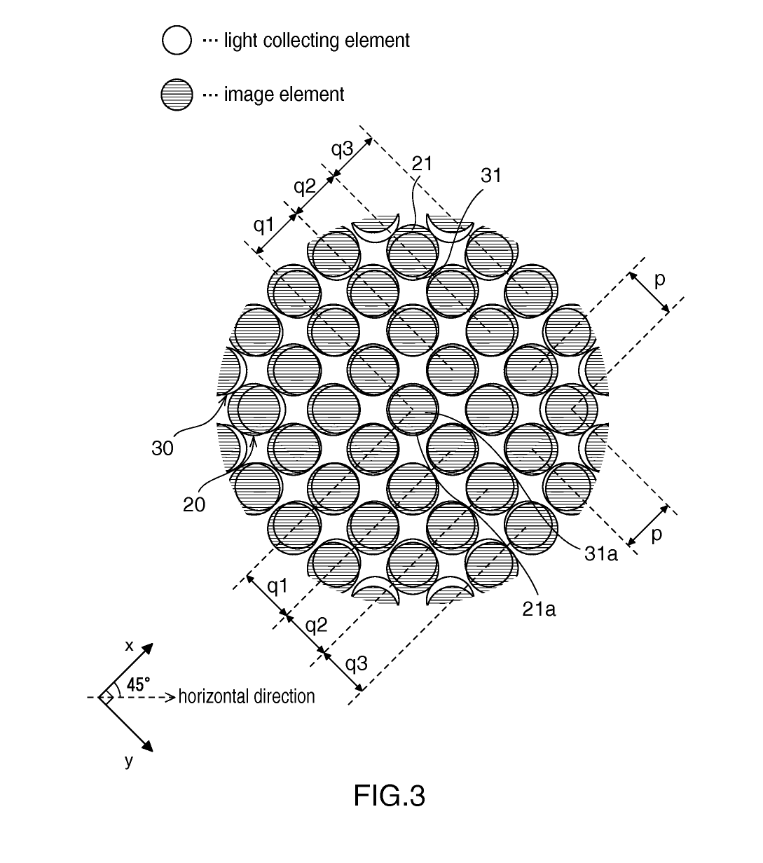

As shown in FIGS. 2 and 3, the aforementioned image element pattern 20 is formed by two-dimensionally arranging a plurality of image elements 21 with an arrangement directionality of image elements 21. Specifically, in the image element pattern 20, the image elements 21 are linearly arranged at an array pitch p in a direction inclined by 45 degrees relative to a horizontal direction (hereinafter referred to as “x direction”) and linearly arranged at an array pitch p in a direction perpendicular to the x direction (hereinafter referred to as “y direction”). Thus, the image elements 21 are arranged two-dimensionally and equally in a matrix form. In the image elements 21 of this embodiment, the diameter of the image element is set to 1.0 mm and the array pitch p is set to 1.1 mm.

The aforementioned light collecting element pattern 30 is formed by two-dimensionally arranging a plurality of convex lens-shaped light collecting elements 31 with the same directionality as the image elements 21, as shown in FIGS. 2 and 3. Specifically, in the light collecting element pattern 30, the light collecting elements 31 are linearly arranged at an array pitch qn in a direction inclined by 45 degrees relative to a horizontal direction (hereinafter referred to as “x direction”) and linearly arranged at an array pitch qn in a direction perpendicular to the x direction (hereinafter referred to as “y direction”). Thus, the light collecting elements 31 are arranged two-dimensionally and equally in a matrix form, and the array pitch qn of the adjacent light collecting elements 31 is set to be smaller than the array pitch p of the image elements 21. As a result, as shown in FIG. 2, it becomes possible to make an enlarged virtual image group Z1 made of enlarged virtual images of image elements 21 appear above the transparent material 10 in a static state with less fluctuation, without being limited on a position to see the enlarged virtual image group. In the light collecting elements 31 of this embodiment, the diameter of the light collecting element is set to 0.95 mm and the array pitch q1 is set to 1.05 mm.

Furthermore, in this light collecting element pattern 30, the array pitch qn of the adjacent light collecting elements 31 is set so to be gradually and continuously smaller from the central portion toward the peripheral edge portion of the light collecting elements 31 along the array direction of the light collecting elements 31. Specifically, as shown in FIG. 2, when the light collecting element 31 located at the central portion is defined as a light collecting element 31a and the array pitch qn of the adjacent light collecting elements 31 is defined as q1, q2, q3 . . . sequentially from the light collecting element 31a toward the peripheral portions, the relationship of p>q1>q2>q3 . . . is met.

Generally, when the array pitch qn of the light collecting elements 31 is smaller than the array pitch p of the image elements 21, the position where the enlarged virtual image Z1 of the image element 21 appears becomes higher when the array pitch qn of the light collecting elements 31 becomes larger as they get closer to the array pitch p of the image elements 21. On the other hand, when the array pitch qn of the light collecting elements 31 becomes smaller as they get further away from the array pitch p of the image elements 21, the position where the enlarged virtual image Z1 of the image elements 21 appears becomes lower.

For this reason, when the array pitch qn of the adjacent light collecting elements 31 becomes gradually and continuously smaller from the light collecting element 31a at the central portion of the light collecting element pattern 30 toward the peripheral portion, as shown in FIG. 2, an enlarged virtual image of the image elements 21 appears above the transparent material 10 while being gradually and continuously lowered from the central portion to the peripheral portion. Thus, a three-dimensional enlarged virtual image group Z1 having a protruded curved surface declining from the central portion to the peripheral portion as a whole can be constituted.

Furthermore, in comparison to a conventional ornamental display in which the array pitch of the image elements changes, the three-dimensionality of the enlarged virtual image group can be improved since the curvature radius of the enlarged virtual image group becomes smaller and the difference of elevation of the enlarged virtual image group becomes clear.

Also, since there will be no need to set a change in the array pitch of the image elements, it becomes easier to set complex shapes to image elements, and the variations of designs of enlarged virtual image groups can be easily increased.

### Second Embodiment

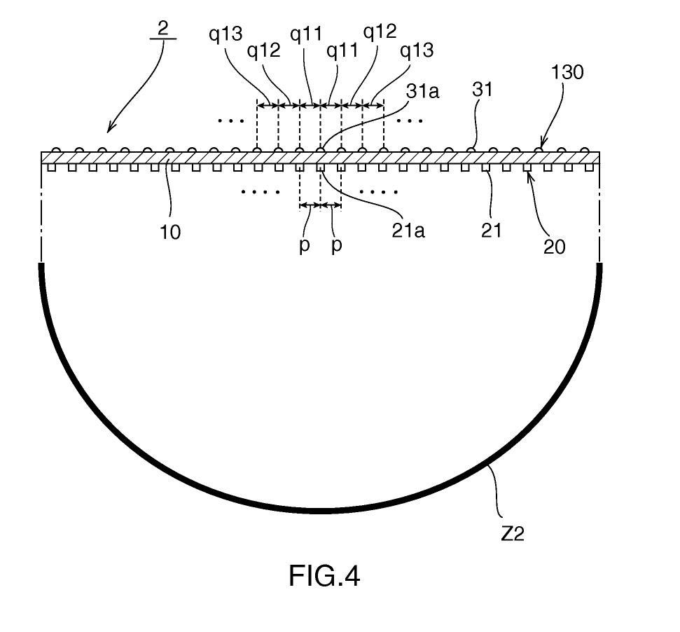

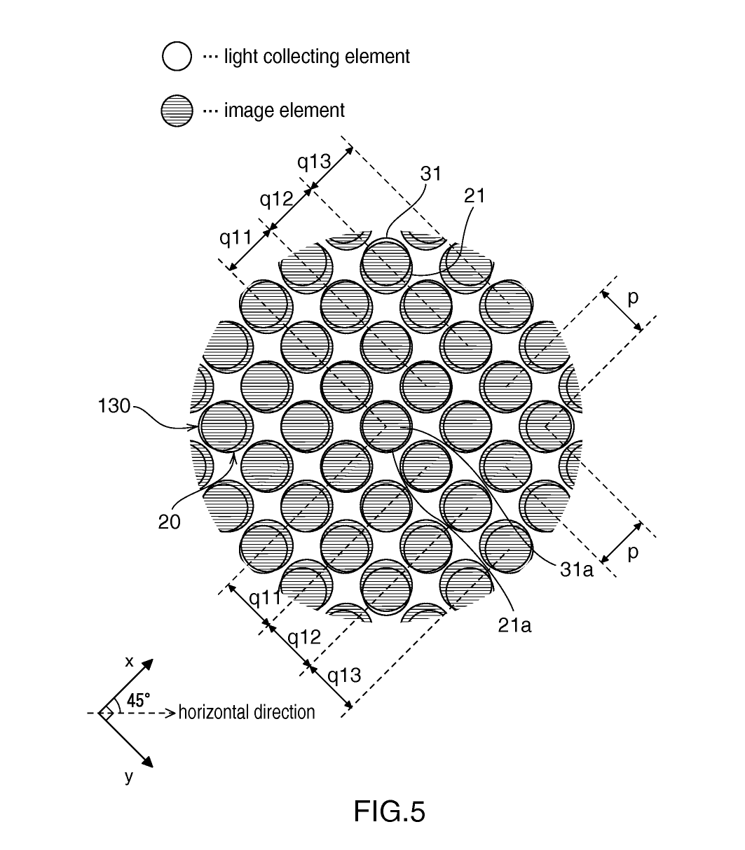

Next, a second embodiment of the ornamental display according to the present invention will be explained with reference to FIGS. 4 and 5. In this embodiment, a case in which an enlarged virtual image group is to be appeared below the transparent material 10 will be explained. Hereinafter, in the ornamental display 2 according to this embodiment, since a light collecting element pattern 130 that is different from the light collecting element pattern 30 of the aforementioned first embodiment 1 is formed on the surface of the transparent material 10, hereinafter, the specific contents thereof will be explained. Duplicate explanations will be omitted by allotting the same symbols to the same structures.

The aforementioned light collecting element pattern 130 is formed by two-dimensionally arranging a plurality of convex lens-shaped light collecting elements 31 in the same direction as the image elements 21 of the image element pattern 20, as shown in FIGS. 4 and 5. Specifically, in the light collecting element pattern 130, light collecting elements 31 are linearly arranged at an array pitch qn in a direction inclined by 45 degrees relative to a horizontal direction (hereinafter referred to as “x direction”) and linearly arranged at an array pitch qn in a direction perpendicular to the x direction (hereinafter referred to as “y direction”). Thus, the image elements 21 are two-dimensionally and equally arranged in a matrix form, and the array pitch qn of the adjacent light collecting elements 31 is set to be larger than the array pitch p of the image elements 21. Therefore, as shown in FIG. 4, it becomes possible to make an enlarged virtual image group Z2 made of enlarged virtual images of image elements 21 appear below the transparent material 10 in a static state with less fluctuation, without being limited on a position to see the enlarged virtual image group. In the light collecting elements 31 of this embodiment, the array pitch q1 is set to 1.15 mm.

Furthermore, in this light collecting element pattern 130, the array pitch qn of the adjacent light collecting elements 31 is set to be gradually and continuously larger from the central portion toward the peripheral edge portion of the light collecting elements 31 along the array direction. Specifically, when the array pitch qn of the adjacent light collecting elements 31 is defined as q11, q12, q13, . . . , sequentially from the light collecting element 31a located at the central portion toward the peripheral portions, the relationship of p<q11<q12<q13 . . . is met.

Generally, when the array pitch qn of the light collecting elements 31 is larger than the array pitch p of the image elements 21, the position where the enlarged virtual image group Z2 of image elements 21 appears becomes deep when the array pitch qn of the light collecting elements 31 becomes smaller as it gets closer to the array pitch p of image elements 21. On the other hand, when the array pitch qn of the light collecting elements 31 gets farther away from the array pitch p of the image elements 21 and becomes larger, the position where the enlarged virtual image Z2 of the image elements 21 appears becomes shallow.

Therefore, since the array pitch qn of the adjacent light collecting elements 31 becomes gradually and continuously larger from the central portion of the light collecting element pattern 30 to the peripheral portion, as shown in FIG. 4, an enlarged virtual image of the image elements 21 appears below the transparent material 10 while being gradually and continuously made shallower from the central portion to the peripheral portion. Thus, a three-dimensional enlarged virtual image group Z2 having a concaved curved surface inclining from the central portion to the peripheral portion as a whole can be constituted.

### Third Embodiment

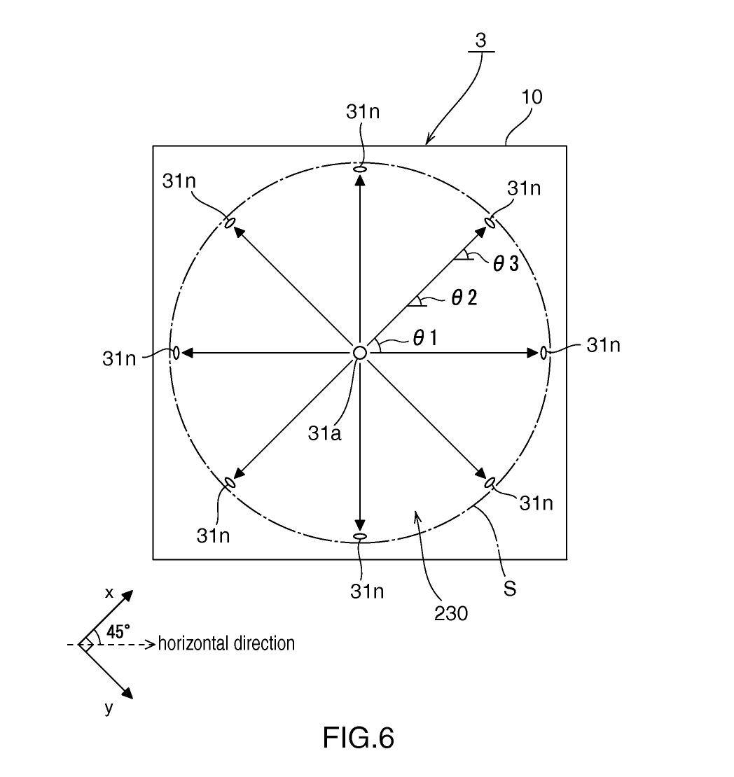

Next, a third embodiment of an ornamental display according to the present invention will be explained with reference to FIGS. 6 to 8. In this embodiment, a case in which a spherical enlarged virtual image group is made to appear will be explained. Hereinafter, in the ornamental display 3 according to this embodiment, a light collecting element pattern 230 that is different from of the light collecting element patterns 30, 130 of the aforementioned first and second embodiments is formed on the surface of the transparent material 10. Therefore, hereinafter, the specific explanation will be made, and duplicate explanations will be omitted by allotting the same symbols to the same structures.

As shown in FIG. 6, the aforementioned light collecting element pattern 230 is formed in a circular region S on the surface of a transparent material 10. Also, the image element pattern 20 of this embodiment is formed in a region corresponding to the circular region S in which the light collecting element pattern 230 is formed on the back surface of the transparent material 10.

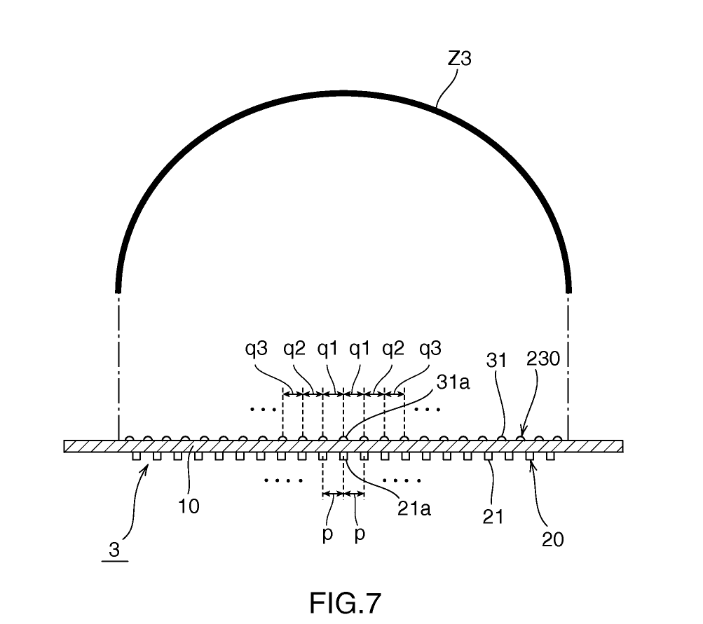

The light collecting element pattern 230 is formed by two-dimensionally arranging a plurality of convex lens-shaped light collecting elements 31 in the same direction as the image elements 21 of the image element pattern 20, as shown in FIGS. 6 and 7. Specifically, in the light collecting element pattern 230, light collecting elements 31 are linearly arranged at an array pitch qn in a direction inclined by 45 degrees relative to a horizontal direction (hereinafter referred to as “x direction”) and linearly arranged at an array pitch qn in a direction perpendicular to the x direction (hereinafter referred to as “y direction”). Thus, the image elements 21 are two-dimensionally and equally arranged in a matrix form, and the array pitch qn of the adjacent light collecting elements 31 is set to be smaller than the array pitch p of the image elements 21. With this, as shown in FIG. 7, an enlarged virtual image group Z3 made of enlarged virtual images of image elements 21 can be made to appear above the transparent material 10 in a static state with less fluctuation, without being limited on a position to see the enlarged virtual image group.

Furthermore, in this light collecting element pattern 230, the array pitch qn of the adjacent light collecting elements 31 is set to be gradually and continuously smaller from the central portion toward the peripheral portion of the light collecting elements 31 along the array direction. Specifically, as shown in FIG. 7, when the light collecting element 31 located at the central portion is defined as a light collecting element 31a and the array pitch qn of the adjacent light collecting elements 31 is defined as q1, q2, q3, . . . , sequentially from the light collecting element 31a toward the peripheral portions, the relationship of p>q1>q2>q3 . . . is met.

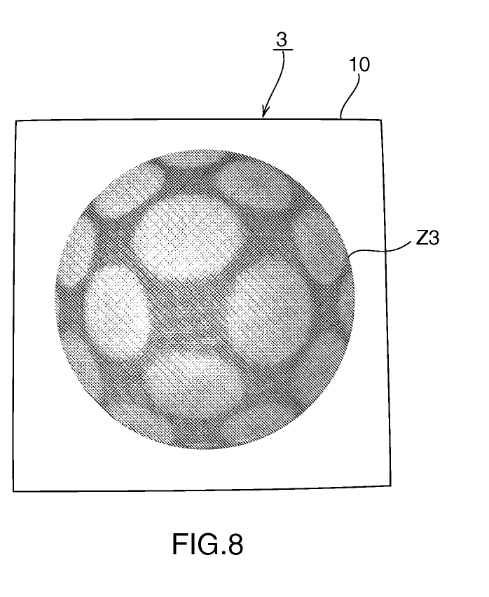

Therefore, when the array pitch qn of the light collecting elements 31 becomes gradually and continuously smaller from the central portion of the light collecting element pattern 230 toward the peripheral edge portion, as shown in FIGS. 7 and 8, an enlarged virtual image of the image elements 21 appears above the transparent material 10 while being gradually and continuously lowered from the central portion to the peripheral edge portion. Thus, a three-dimensional enlarged virtual image group Z3 having a protruded curved surface that is declining from the central portion to the peripheral portion as a whole can be constituted.

Furthermore, in comparison to a conventional ornamental display in which the array pitch of the image elements is changed, the three-dimensionality of the enlarged virtual image group can be improved since the curvature radius of the enlarged virtual image group is smaller and the difference of elevation of the enlarged virtual image group becomes clear. Also, since there will be no need to set a change in the array pitch of the image elements, it becomes easier to set complex shapes to image elements, and the variations of designs of enlarged virtual image groups can be easily increased.

Also, the light collecting element pattern 230 is formed so that the array pitch of the adjacent light collecting elements 31 gradually and continuously changes in a range of 0.3% or less along the array direction of the light collecting elements 31. The rate of change of the array pitch of the light collecting elements 31 is set to be 0.3% or less because when an array pitch exceeds the ratio, the curved surface of the enlarged virtual image of the image elements 21 could not be smooth. Therefore, by setting the rate of change of the array pitch of the light collecting elements to 0.3% or less, the height and the depth of the enlarged virtual image of the image element 31 gradually and continuously change more assuredly, thereby making it possible to make the curved surface of the enlarged virtual image group Z3 smooth.

Also, the light collecting element pattern 230 is formed so that the shape of each light collecting element 31 gradually and continuously changes along the array direction of the light collecting elements 31. In this embodiment, in the light collecting element pattern 230, the diameter of each light collecting element 31 in the array direction changes so as to become smaller in the array direction of the light collecting elements. More specifically, as shown in FIG. 6, in the light collecting element pattern 230, from the light collecting element 31a at the central portion to the light collecting elements 31n at the peripheral portion, the shape of the light collecting element 31 gradually and continuously changes from a circle shape to an oval shape extending in a direction perpendicular to the array direction.

Thus, as shown in FIG. 8, the shape of the enlarged virtual image group of the image elements 31 can be changed by changing the shapes of the light collecting elements 31 without changing the shapes of the image elements 21. Also, since the enlarged virtual image of the image elements 21 become smaller in the array direction together with the difference of elevation of the enlarged virtual images of the image elements 21, the curved surface of the enlarged virtual image group can be shown to be in a close to a three-dimensional object. Furthermore, by an easy setting of the shape of the light collecting elements 31 in which it changes from a circular shape to an oval shape, the curved surface of the enlarged virtual image group Z3 can be shown as a state close to an actual three-dimensional object.

Here, it is preferable that the diameter of the light collecting element 31 in the array direction thereof is set to become smaller in a range of 0.3% or less along the array direction of the light collecting elements 31. With this, the curved surface of the enlarged virtual image group can be shown as a state more closer to an actual three-dimensional object.

The “actual three-dimensional object” refers to a spherical three-dimensional object having the same shape and size as the enlarged virtual image group Z3. In other words, it becomes possible to constitute the enlarged virtual image group Z3 so as to be seen in the same way as when an actual three-dimensional object is seen in reality.

Also, the light collecting element pattern 230 is set so that the array direction of the adjacent light collecting elements 31 gradually and continuously turns every light collecting element 31. Specifically, in the light collecting element pattern 230, when three continuously adjacent light collecting elements 31A, 31B, and 31C form an array direction, the angle of a linear extended line connecting the light collecting element 31A and the adjacent light collecting element 31B, and a linear line connecting the light collecting element 31B and the adjacent light collecting element 31C turns in a range of −0.3 degrees to +0.3 degrees. Therefore, in the light collecting element pattern 230 as a whole, the array direction of the adjacent light collecting elements 31 gradually and continuously turns in a range of −0.3 degrees to +0.3 degrees.

In this embodiment, as shown in FIG. 6, the array direction of the adjacent light collecting elements 31 from the light collecting elements 31a at the central portion to the light collecting element 31n at the peripheral portion gradually and continuously turns so as to satisfy the relationship of θ1<θ2<θ3, where: the narrow angle of the array direction at the position of the light collecting element 31a at the central portion and the horizontal direction is θ1, the narrow angle of the array direction at an intermediate portion of the central portion and the peripheral portion and the horizontal direction is θ2, and the narrow angle of the array direction at the position of the light collecting element 31n at the peripheral portion and the horizontal direction is θ3. The angle in which the array direction of the light collecting elements 31 turns (turning in the counterclockwise direction of FIG. 6) is in a range of 0 to +0.3 degrees. In this embodiment, θ1=45 degrees and θ3=45.6 degrees as it gradually and continuously turns.

Thus, since the enlarged virtual images of the image elements 31 appear while turning, an enlarged virtual image group Z3 having a distorted curved surface as a whole can be constituted. Also, since an enlarged virtual image of image elements 21 appears while turning at a minute angle because the turning angle is set to a range of −0.3 to +0.3 degrees, the distortion seen in an actual three-dimensional object can be displayed on the curved surface of the enlarged virtual image group Z3.

### Fourth Embodiment

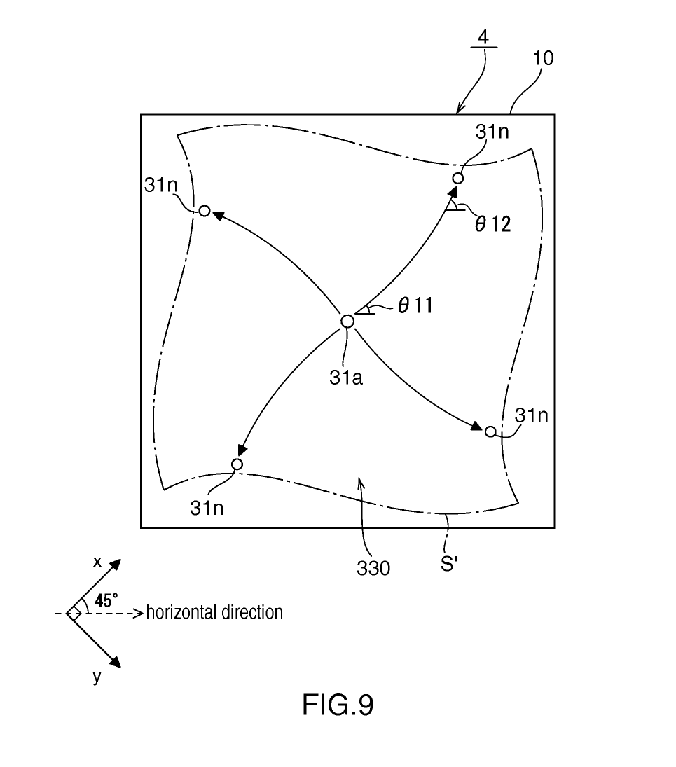

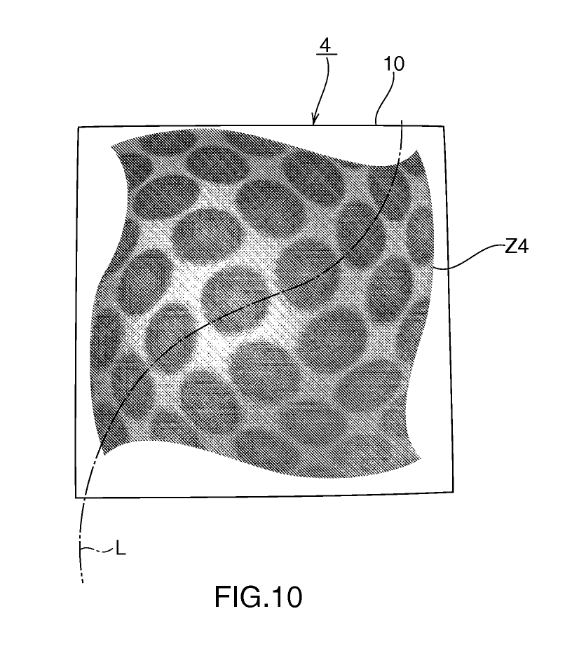

Next, a fourth embodiment of an ornamental display according to the present invention will be explained with reference with FIGS. 9 and 10. In this embodiment, a case in which the turning of the position of the enlarged virtual image of the image elements 31 is increased will be explained. Hereinafter, in the ornamental display 4 according to this embodiment, a light collecting element pattern 330 that is different from the light collecting element patterns 30, 130, and 230 is formed on the front surface of the transparent material 10. Therefore, hereinafter, specific contents will be explained and duplicate explanations will be omitted by allotting the same symbols to the same structures.

The aforementioned light collecting element pattern 330 is formed by two-dimensionally arranging a plurality of convex lens-shaped light collecting elements 31 in approximately the same direction as the image elements 21 of the image element pattern 20 at an array pitch qn smaller than an array pitch p of the image elements 21, in the same manner as in the first embodiment.

Also, the light collecting element pattern 330 is formed in an approximately rectangular region S′ on the surface of the transparent material 10, in which the four sides are curved into a S shape, respectively, as shown in FIG. 9. Furthermore, the image element pattern 20 of this embodiment is formed on the back surface of the transparent material 10 at a region corresponding to the approximately rectangular region S′ in which the light collecting element pattern 330 is formed.

The light collecting element pattern 330 is set so that the array pitch qn of the adjacent light collecting elements 31 gradually and continuously becomes smaller from the light collecting element 31a at the central portion to the light collecting element 31n at the peripheral edge portion along the array direction of the light collecting elements 31.

Furthermore, the light collecting element pattern 330 is formed so that the array direction of the light collecting elements 31 gradually and continuously turns from the central portion to the peripheral portion along the array direction of the light collecting elements 31. Specifically, for the array direction of the light collecting elements 31, in the direction from the light collecting elements 31a at the central portion to the light collecting elements 31n at the peripheral portion, the array direction of the adjacent light collecting elements 31 gradually and continuously turns in one direction (counterclockwise direction of FIG. 9) every light collecting element 31 as shown in FIG. 9.

Also, the light collecting element pattern 330 satisfies a relationship of θ11<θ12, where the narrow angle of the array direction and the horizontal direction at the position of the light collecting element 31a at the central portion is θ11, and the narrow angle of the array direction and the horizontal direction at the position of the light collecting element 31n at the peripheral portion is θ12. Also, θ11 of this embodiment and θ1 of the third embodiment 3 satisfies the relationship of θ1=θ11, and θ12 of this embodiment and θ3 of the third embodiment satisfies a relationship of θ3<θ12.

In this way, the turning of the array direction of the light collecting elements 31 of this embodiment is larger than the turning of the array direction of the light collecting elements 31 of the third embodiment. Therefore, the position where the enlarged virtual image of the image elements 21 appears gradually, continuously, and largely turns together with the change in the array direction of the light collecting elements 31, thereby making it possible to largely curve the line of enlarged virtual images of the image elements 21 linearly arranged in the image element pattern 20 as shown by the dashed line L, as shown in FIG. 10. Therefore, since the curve of the line L of the enlarged virtual image of the image elements 21 can be a design (decoration) formed on the curved surface of the three-dimensional enlarged virtual image group Z4, it can be a variation of a design of the enlarged virtual image group Z4.

In this embodiment and the third embodiment, the explanation was directed to the case in which the array direction of the adjacent light collecting elements 31 gradually and continuously turns in one direction every light collecting element 31. However, it can be configured such that the array direction turns to the opposite direction in the middle. Also, the turning of the array direction of the light collecting elements 31 can be in the clockwise direction.

### Fifth Embodiment

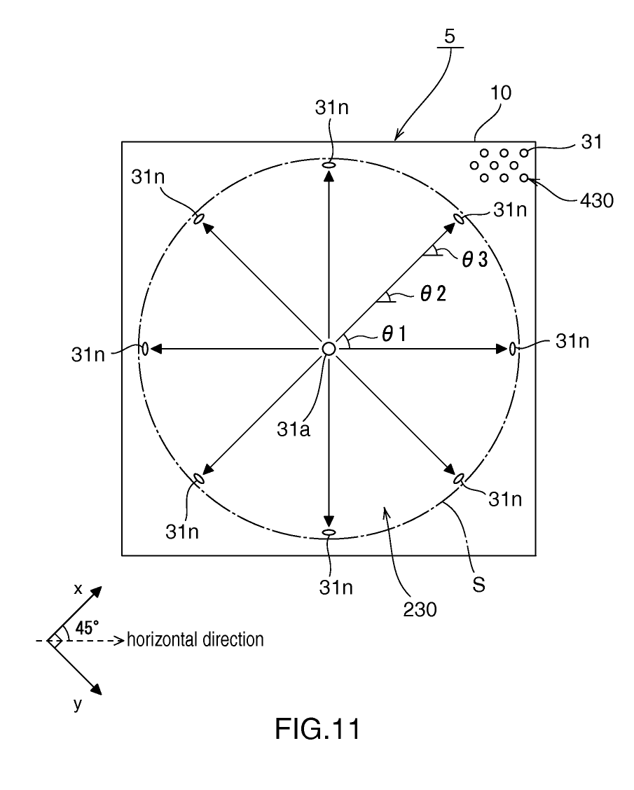

Next, a fifth embodiment of an ornamental display according to the present invention will be explained with reference to FIGS. 11 to 13. In this embodiment, the explanation will be directed to a case in which a spherical enlarged virtual image group appears in a way that they stand out. In addition, in the ornamental display 5 according to this embodiment, a second light collecting element pattern 430 is formed outside of the light collecting element pattern 230 of the ornamental display 3 of the third embodiment. Hereinafter, the specific contents will be explained, and duplicate explanations will be omitted by allotting the same symbols to the same structures.

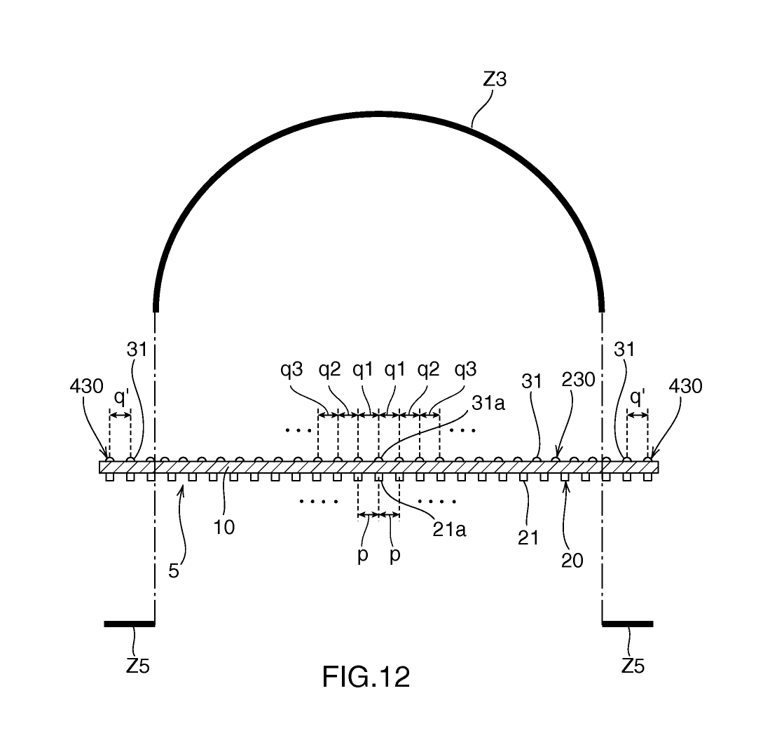

In the second light collecting element pattern 430, as shown in FIGS. 11 and 12, the light collecting elements 31 are arranged two-dimensionally in a matrix form in the x and y directions outside of the light collecting element pattern 230 of the ornamental display 3, and the light collecting elements 31 are set to be arranged at a uniform array pitch q′ larger than the array pitch p of the image elements 21.

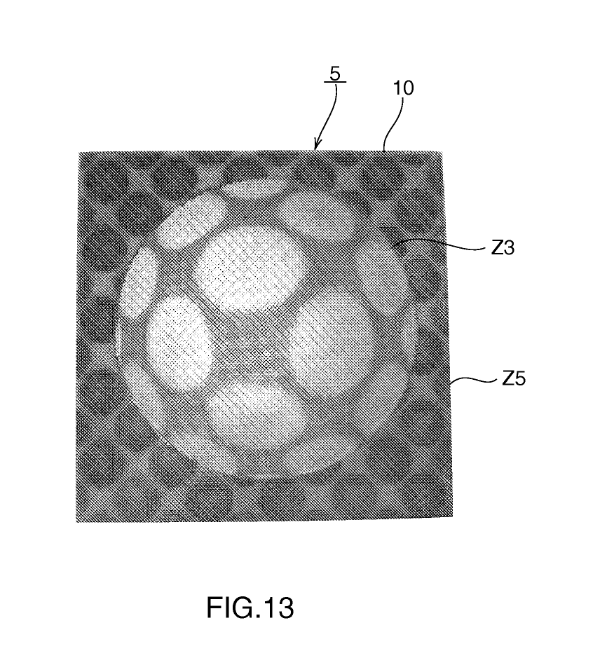

Therefore, as shown in FIGS. 12 and 13, an enlarged virtual image group Z3 of image elements 21 of the light collecting element pattern 230 appears above the transparent material 10, and an enlarged virtual image group Z5 of the image elements 21 of the second light collecting element pattern 430 appears below the transparent material 10. Thus, since a difference of elevation can be formed between the enlarged virtual image group Z3 of the light collecting element pattern 230 and the enlarged virtual image group Z5 of the second light collecting element pattern 430, it is possible to constitute a perspective three-dimensional enlarged virtual image group Z3 that stand out more.

In this embodiment, a case in which one second light collecting element pattern 430 is provided as another light collecting element pattern outside of the light collecting element pattern 230 was explained, but a plurality of other light collecting element patterns having different array pitches can be provided.

Also, the explanation was directed to the case in which the enlarged virtual image group Z3 of the light collecting element pattern 230 appears above the transparent material 10 and the enlarged virtual image group Z5 of the second light collecting element pattern 430 appears below the transparent material 10, but it can be configured such that the enlarged virtual image Z3 of the light collecting element pattern 230 and the enlarged virtual image group Z5 of the second light collecting element pattern 430 appear above the transparent material 10. In this case, it can be configured such that the enlarged virtual image group Z3 of the light collecting element pattern 230 appears above than the enlarged virtual image group Z5 of the second light collecting element pattern 430.

### Sixth Embodiment

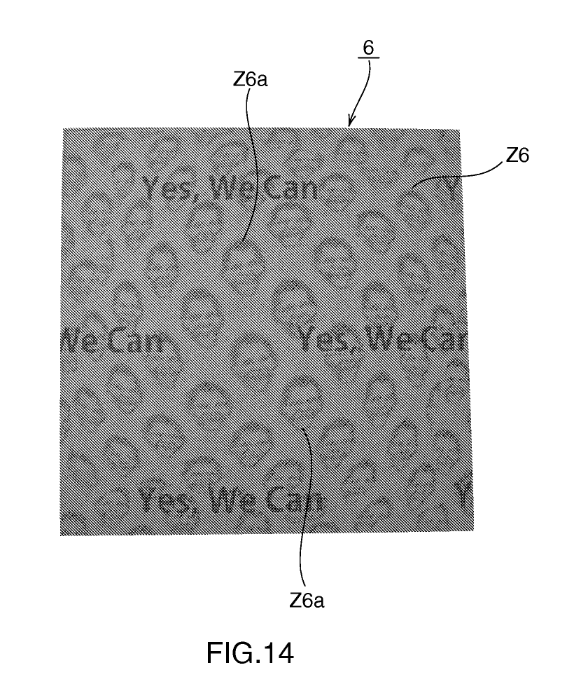

Next, a sixth embodiment of an ornamental display according to the present invention will be explained with reference to FIG. 14. In this embodiment, a case in which a designed enlarged virtual image group appears will be explained. In the ornamental display 6 according to this embodiment, since a second image element pattern different from the image element pattern 20 is formed on the back surface of the transparent material 10 of the aforementioned first embodiment, the specific contents will be explained, and duplicate explanations will be omitted by allotting the same symbols to the same structures as first embodiment.

In the aforementioned second image element pattern, in the same manner as in the first embodiment, a plurality of image elements are two-dimensionally and equally arranged in a matrix form at an array pitch p with the image elements directionally arranged. The image element of this embodiment is formed into a shape imitating a person's face. Therefore, as shown in FIG. 14, it becomes possible to appear an enlarged virtual image group Z6 designed with enlarged virtual images Z6a of image elements having shapes of a person's face above the transparent material 10 in a static state with less fluctuation, without being limited on a position to see the enlarged virtual image group.

In the present invention, since the array pitch of the light collecting elements is to be changed rather than changing the array pitch of the image elements, an enlarged virtual image of an image element having a complex shape imitating a person's face such as this one can be displayed. That is, in a conventional ornamental display, since the array pitch of the image elements was changed, the array pitch of the image elements and the shape of the image elements needed to be set at the same time. Therefore, there was a problem that it was difficult to set complex shapes for image elements. However, since the array pitch of the light collecting element is changed in the present invention, there is no need to always change the array pitch of the image elements. Therefore, since there are fewer factors to be set for image elements, it becomes easier to set complex shapes for image elements and the variation in designs of enlarged virtual image group of image elements can be increased.

### Seventh Embodiment

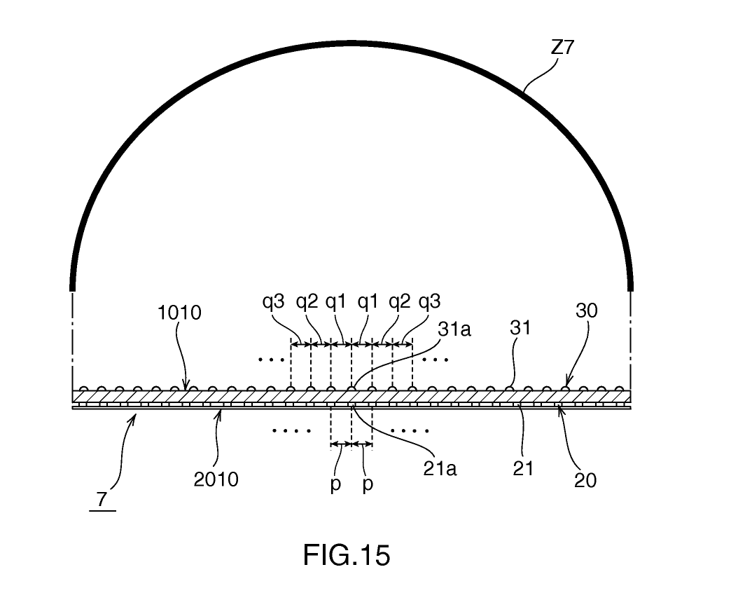

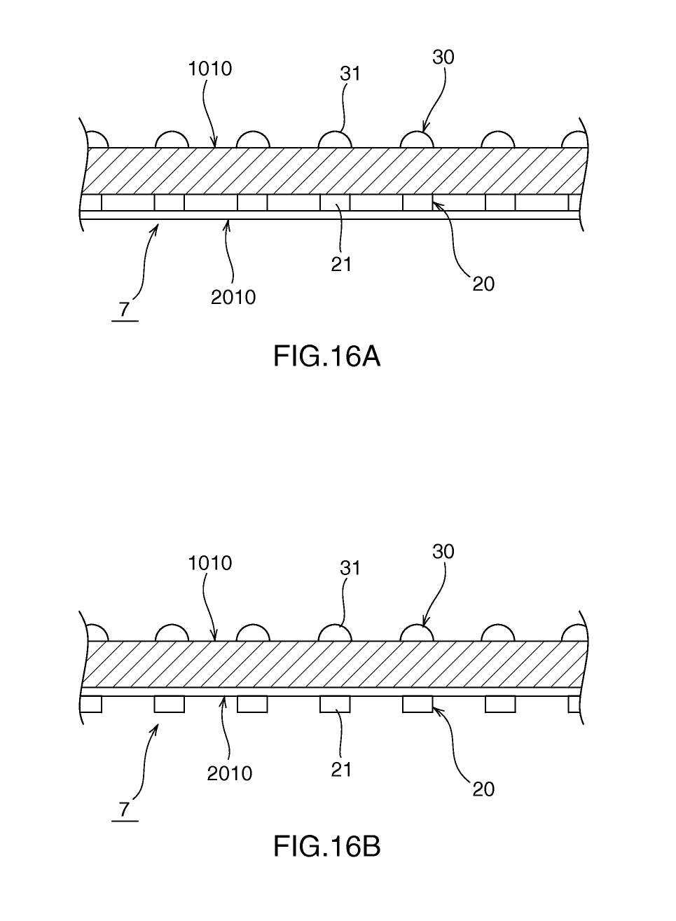

Next, a seventh embodiment of an ornamental display according to the present invention will be explained with reference to FIGS. 15 and 16. In this embodiment, a case in which an enlarged virtual image group of image elements appears upwards by a separator-type ornamental display constituted by an image element sheet 2010 and a transparent material 1010 having light collecting elements will be explained. Hereinafter, the differences in the structures of the ornamental display 7 according to this embodiment and the ornamental displays of the aforementioned embodiments will be explained, and duplicate explanations will be omitted by allotting the same symbols to the same structures.

The ornamental display 7 of this embodiment is equipped with an image element sheet 2010 on which a plurality of image elements 21 are formed, and a transparent material 1010 having light collecting elements 31 on which a plurality of convex lens-shaped light collecting elements 31 are formed, as shown in FIG. 15.

The image element sheet 2010 is a sheet-shaped member in which a plurality of image elements 21 made of clear or non-clear ink colored are arranged two-dimensionally on the surface thereof to form an image element pattern 20 with the image elements 21 directionally arranged, as shown in FIG. 16(a). In the image element pattern 20, in the same manner as in the image element pattern 20 of the first embodiment, image elements 21 are linearly arranged at an array pitch p in a direction inclined by 45 degrees relative to a horizontal direction (hereinafter referred to as “x direction”) and linearly arranged at an array pitch p in a direction perpendicular to the x direction (hereinafter referred to as “y direction”). Thus, the image elements 21 are two-dimensionally and equally arranged in a matrix form.

The transparent material 1010 having light collecting elements is a plate-like transparent member in which a plurality of image elements 31 made of clear or non-clear ink colored are arranged two-dimensionally on the surface thereof to form an image element pattern 30 with the image elements 21 of the image element pattern 20 directionally arranged. In the image element pattern 30, in the same manner as in the image element pattern 30 of the first embodiment, light collecting elements 31 are linearly arranged at an array pitch qn in a direction inclined by 45 degrees relative to a horizontal direction and linearly arranged at an array pitch qn in a y direction perpendicular to the x direction. Thus, the light collecting elements 31 are two-dimensionally and equally arranged in a matrix form. Also, the array pitch of the adjacent light collecting elements 31 is set to be smaller than the array pitch p of the image elements 21 and gradually and continuously smaller from the central portion to the peripheral edge portion along the array direction of the light collecting elements 31.

In the ornamental display 7, the surface of an image element sheet 2010 (surface of the image element pattern 20 side) is adhered to the back surface of the transparent material 1010 having light collecting elements using an adhesive agent. Thus, the ornamental display 7 has a similar structure as the transparent material 10, the image element pattern 20, and the light collecting element pattern 30 of the ornamental display 1 of the first embodiment. Therefore, as shown in FIG. 15, in the ornamental display 7, it becomes possible to make an enlarged virtual image group Z7 of enlarged virtual images of image elements 21 appear above the transparent material 1010 in a static state with less fluctuation, without being limited on a position to see the enlarged virtual image group. Also, a three-dimensional enlarged virtual image group Z7 having a protruded curved surface which is declining from the central portion to the peripheral edge portion as a whole can be constituted, wherein the enlarged virtual image of image elements 21 are displayed above the transparent material 1010 having light collecting elements while gradually and continuously changing the height of the enlarged virtual images.

In the aforementioned seventh embodiment, the explanation was directed to the case in which the surface of the image element sheet 2010 was adhered to the back surface of the transparent material 1010 having light collecting elements using an adhesive agent, but the back surface (the surface opposite from the image element pattern 20 side) can be adhered. For example, as shown in FIG. 16(b), the back surface of the image element sheet 2010 can be adhered to the back surface of the transparent material 1010 having light collecting elements using an adhesive agent.

Also, a background layer forming the background of the image element pattern 20 can be formed on the back surface of the image element sheet 2010.

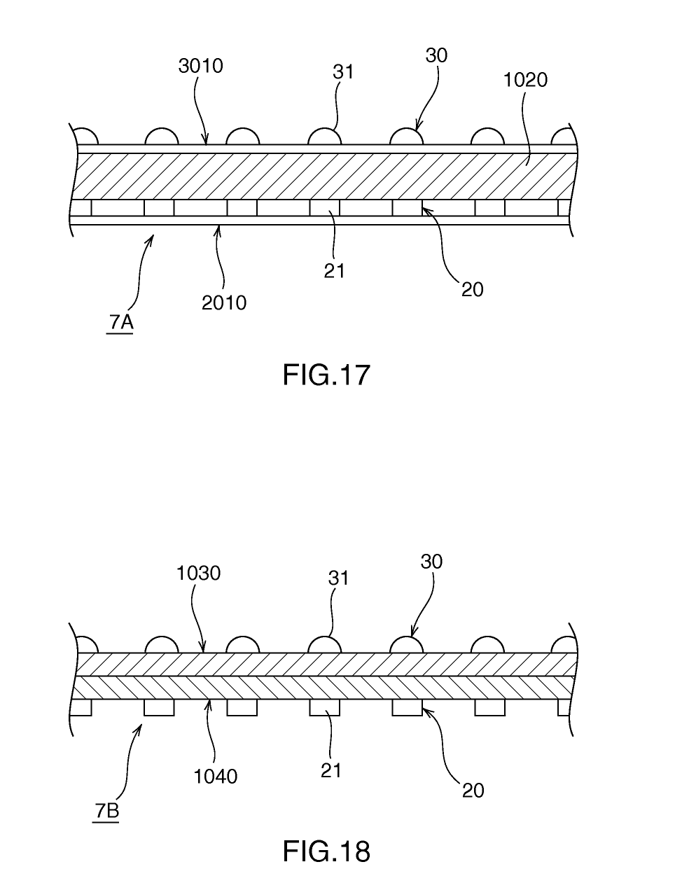

Next, a first modified example of this embodiment will be explained with reference to FIG. 17.

The ornamental display 7A according to the first modified example is a separator-type ornamental display including a transparent material 1020, an image element sheet 2010, and a light collecting element sheet 3010.

The aforementioned transparent material 1020 is a plate-shaped transparent member having a flatly formed surface and back surface. Also, the aforementioned image element sheet 2010 is the same as the one used in the seventh embodiment described above.

The aforementioned light collecting element sheet 3010 is a sheet-like transparent member in which a plurality of convex lens-shaped light collecting elements 31 of colored or non-colored transparent ink are arranged two-dimensionally on the surface thereof to form a light collecting element pattern 30 with the light collecting elements 31 array directionally the same as the image elements 21 of the image element pattern 20.

In the ornamental display 7A, the surface of the transparent material 1020 is adhered to the back surface of the light condensing sheet 3010 (surface opposite from the light collecting element pattern 30 side) using an adhesive agent, and the surface of the image elements sheet 2010 (surface of the image element pattern 20 side) is adhered to the back surface of the transparent material 1020 using an adhesive material. Thus, the ornamental display 7A can have the same structure as the transparent material 10, the image element pattern 20, and the light collecting element pattern 30 of the ornamental display 1 of the first embodiment, in the same manner as in the ornamental display 7 described above.

Furthermore, a second modified example of this embodiment will be explained with reference to FIG. 18.

The ornamental display 7B according to the second modified example is a separator-type ornamental display including a transparent material 1030 having image elements and a transparent material 1040 having light collecting elements, as shown in FIG. 18.

The transparent material 1030 having image elements is a plate-shaped transparent member in which a plurality of image elements 21 made of colored transparent or non-transparent ink are arranged two-dimensionally on the surface thereof to form an image element pattern 20 with the image elements 21 directionally arranged.

The aforementioned transparent material 1040 having light collecting elements in which a plurality of light collecting elements 31 made of colored or uncolored transparent ink are arranged two-dimensionally on the surface thereof to form a light collecting element pattern 30 with the light collecting elements 31 arranged directionally the same as the image elements 21 of the image element pattern 20.

In the ornamental display 7B, the back surfaces of the transparent material 1030 having image elements and the transparent material 1040 having light collecting elements are adhered by an adhesive agent. Thus, the ornamental display 7B can have the same structure as the transparent material 10, the image element pattern 20, and the light collecting element pattern 30 of the ornamental display 1 of the first embodiment, similarly to the ornamental display 7 described above.

Furthermore, in this embodiment, the explanation was directed to the case in which the image element sheet 2010 or the light collecting element sheet 3010 is adhered to a transparent material using an adhesive agent, but they can be adhered using other methods.

Also, in the ornamental display 7B according to the second modified example, it is depicted such that the thicknesses of the transparent material having image elements and the transparent material having light collecting elements are the same in FIG. 18, but it is not required that the thicknesses are the same. For example, when an enlarged virtual image group is to be displayed when the total of the thicknesses of the transparent material having image elements and the transparent material having light collecting elements of the ornamental display 7B is 3 mm, the thickness of the transparent material 1030 having light collecting elements can be set to 2 mm and the thickness of the transparent material having image elements can be set to 1 mm for the total thickness to be 3 mm.

### Eighth Embodiment

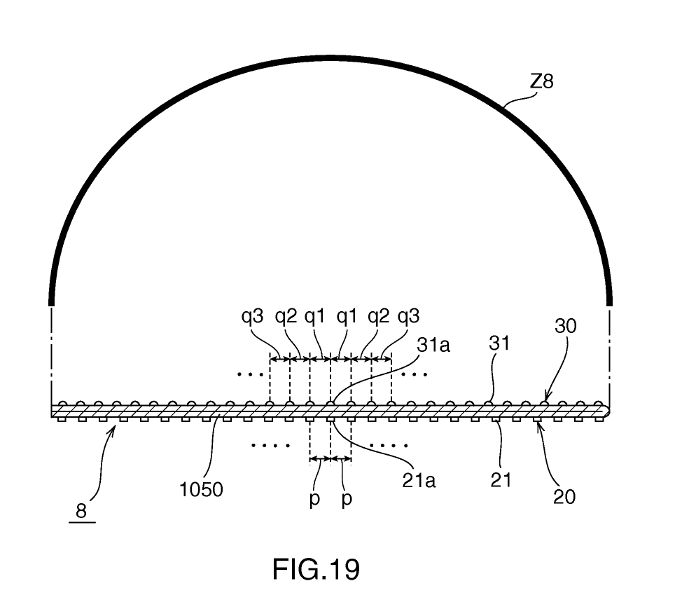

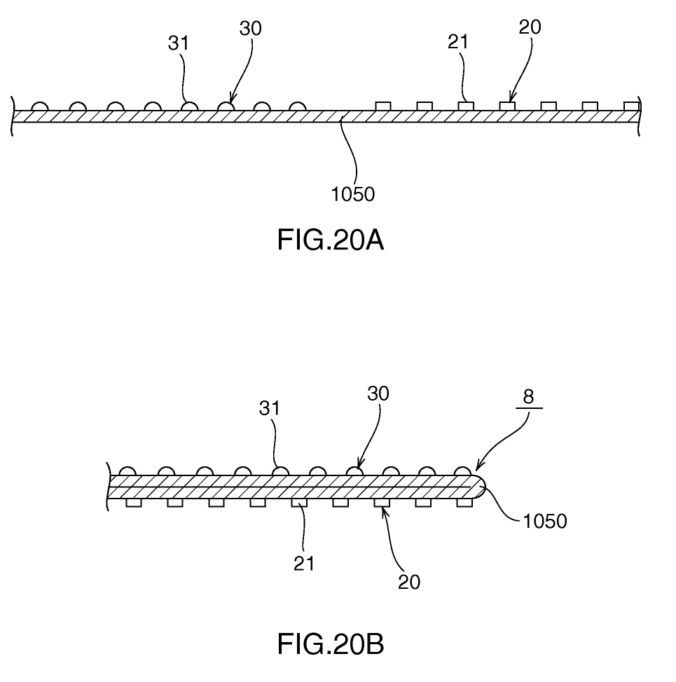

Next, an eighth embodiment of the ornamental display according to the present invention will be explained with reference to FIGS. 19 and 20. In this embodiment, a case in which an enlarged virtual image group of image elements appears above a folded-type ornamental displayed body made by folding back a transparent material 1050 to which the light collecting element pattern 30 and the image element pattern 20 are formed on the same surface thereof will be explained. Hereinafter, the differences in the structures of the ornamental display 8 according to this embodiment and the ornamental displays of the aforementioned embodiments will be explained, and duplicate explanations will be omitted by allotting the same symbols to the same structures.

In the ornamental display 8 of this embodiment, a plurality of convex lens-shaped light collecting elements 31 are arranged two-dimensionally to form the light collecting element pattern 30 on a portion of the surface thereof with the light collecting elements 31 arranged directionally. Also, a plurality of image elements 21 are arranged two-dimensionally on another portion of the same surface of the ornamental display 8 to form the image element pattern 20 with the image elements 20 arranged directionally the same as the light collecting elements 31 of the light collecting element pattern 30. Furthermore, as shown in FIG. 20(b), the transparent material 1050 is folded back between the light collecting element pattern 30 and the image element pattern 20 in a manner such that the light condensing pattern 30 and the image element pattern 20 are positioned outside, and the opposing back surfaces of the transparent material 1050 are adhered by an adhesive agent.

Thus, the ornamental display 8 has a similar structure as the transparent material 10, the image element pattern 20, and the light collecting element pattern 30 of the ornamental display 1 of the first embodiment. Therefore, as shown in FIG. 19, in the ornamental display 8, it become possible to make an enlarged virtual image group Z8 of enlarged virtual images of image elements 21a appear above a transparent material 1050 (light collecting element pattern 30 side) in a static state with little fluctuation, without being limited on a position to see the enlarged virtual image group. Also, a three-dimensional enlarged virtual image group Z8 having a protruded curved surface, wherein an enlarged virtual image of the image elements 21 appears above the transparent material 1050 having light collecting elements while gradually and continuously changing height, and declining from the central portion to the peripheral edge portion as a whole, can be constituted.

Furthermore, in the aforementioned embodiments, the shapes, the array pitches, and the sizes of the light collecting elements 31 and the image elements 21 are not limited to the aforementioned ones.

The array direction of the light collecting elements 31 and the image elements 21 is not required to be an orthogonal pattern, and can be an intersecting pattern of 30 degrees, 60 degrees, or other angles.

A case in which the array pitch p of the image elements 21 is uniform for the image element pattern 20 was explained, but the array pitch of the image elements 21 can be arbitrarily changed.

A case in which the light collecting element pattern 30 and the image element pattern 20 were formed by printing was explained, but they can be formed by other methods. In addition, when forming them by printing, it is possible to use a variety of publically-known technologies such as offset printing and inkjet printing.

Also, cases in which the transparent materials 10, 1010, 1020, 1030, and 1040 are transparent were explained, but they can be semi-transparent.

Cases in which the transparent materials 10, 1010, 1020, 1030, and 1040 are plate-shaped were explained, but they can be sheet-shaped.

Cases in which the image element patterns 20 and the light collecting element patterns 30 of ornamental displaying bodies 7, 7A, 7B, and 8 wre structured in the same manner as in the first embodiment were explained, but they can be made to have similar structures as the second embodiment. Therefore, it becomes possible to make enlarged virtual image groups of enlarged virtual images of image elements 21 appear above a transparent material having light collecting elements in a static state with less fluctuation, without being limited on a position to see the enlarged virtual image group. Also, it becomes possible to constitute a three-dimensional enlarged virtual image group having a dented curved surface, wherein an enlarged virtual image of the image elements 21 appears below the transparent material 1050 having light collecting elements while gradually and continuously changing the depth thereof, and declining from the central portion to the peripheral edge portion as a whole.

Also, the above explanation was directed to cases in which the ornamental displays 1 to 8 are single unit products, but they can be used for decorating a variety of products such as outer panels of amusement machines and gaming machines, packaging boxes, advertising bodies, ornaments, and display devices. Thus, the ornamental effects of the peripheral edge portion of digital photo frames as a display device can be improved, and when making enlarged virtual image groups appear below ornamental displays 1 to 8, it is possible to make still images and moving images of the digital photo frame appear in a standing out state. Therefore, it is possible to strongly drawn people's attention and improve their buying intentions by being used as ornamentations of various products.

The embodiments of the present invention were explained above with reference to drawings, but the present invention is not limited to the illustrated embodiments. A variety of modifications and variations can be added to the illustrated embodiments within a range of being the same or similar to the present invention.

### DESCRIPTION OF THE REFERENCE NUMERALS

1-7, 7A, 7B, 8: ornamental display
10, 1010, 1020, 1030, 1040, 1050: transparent material
20: image element pattern
21: image element
21a: image element of central portion
30, 130, 230, 330: light collecting element pattern
31: light collecting element
31a: light collecting element at the central portion
31n: light collecting element at the peripheral portion
430: second light collecting element pattern
2010: image element sheet
3010: light collecting element sheet

1. An ornamental display comprising:
a sheet-like or plate-like transparent material;
a plurality of convex lens-shaped light collecting elements arranged two-dimensionally on one surface of the transparent material to form a light collecting element pattern; and
a plurality of image elements arranged two-dimensionally on the other surface of the transparent material to form an image element pattern,
wherein the light collecting element pattern and the image element pattern are formed so that an array pitch of the light collecting elements and an array pitch of the image elements differ from each other, whereby an enlarged virtual image of the image element appears on one side or the other side of the transparent material, and
wherein the light collecting element pattern is formed such that an array pitch of adjacent light collecting elements changes gradually and continuously to make the enlarged virtual image of each image element appear on the one side or the other side of the transparent element while gradually and continuously changing a height or a depth of the enlarged virtual image, which forms a three-dimensional enlarged virtual image group having a curved surface as a whole.

2. The ornamental display as recited in claim 1, wherein the light collecting element pattern is formed so that the array pitch of the adjacent light collecting elements gradually and continuously changes in a range of 0.3% or less along an array direction of the light collecting elements.

3. The ornamental display as recited in claim 1, wherein the light collecting element pattern is formed so that a shape of each light collecting element gradually and continuously changes along an array direction of the light collecting elements.

4. The ornamental display as recited in claim 1, wherein the light collecting element pattern is formed so that a diameter of each light collecting element in an array direction of the light collecting elements changes so as to decrease along the array direction of the light collecting elements.

5. The ornamental display as recited in claim 4, wherein the light collecting element pattern is formed so that the diameter of each light collecting elements in the array direction changes so as to decrease in a range of 0.3% or less along the array direction of the light collecting elements

6. The ornamental display as recited in claim 3, wherein the light collecting element pattern is formed so that a shape of each light collecting element changes gradually and continuously from a circular shape to an oval shape smaller in diameter in the array direction along the array direction of the light collecting elements.

7. The ornamental display as recited in claim 1, wherein the light collecting element pattern is formed so that the array direction of adjacent light collecting elements turns gradually and continuously every light collecting element.

8. The ornamental display as recited in claim 7, wherein the light collecting element pattern is formed so that the array direction of adjacent light collecting elements turns gradually and continuously every light collecting element in a range of −0.3 degrees to +0.3 degrees.

9. The ornamental display as recited in claim 1, wherein a second light collecting element pattern is provided outside of the light collecting element pattern so that an enlarged virtual image group of the light collecting element pattern appears above an enlarged virtual image group appeared by the second light collecting element pattern.

10. An ornamental display comprising:
a sheet or plate-like transparent material;
a plurality of convex lens-shaped light collecting elements are arranged two-dimensionally on one surface of the transparent material to form a light collecting element pattern;
an image element sheet; and
a plurality of image elements arranged two-dimensionally on the image element sheet to form an image element pattern,
wherein the image element sheet is adhered to the other surface of the transparent material having the light collecting elements,
wherein the light collecting element pattern and the image element pattern are formed so that an array pitch of the light collecting elements and an array pitch of the image elements differ from each other, and
wherein the light collecting element pattern is formed such that an array pitch of adjacent light collecting elements changes gradually and continuously to make the enlarged virtual image of each image element appear on one side or the other side of the transparent element having the light collecting elements while gradually and continuously changing a height or a depth of the enlarged virtual image of each image element, which forms a three-dimensional enlarged virtual image group having a curved surface as a whole.

11. A transparent material having light collecting elements for use in the ornamental display as recited in claim 10,
wherein the light collecting elements includes a plurality of convex lens-shaped light collecting elements arranged two-dimensionally on one surface of the transparent material to form a light collecting element pattern,
wherein, when an image element sheet in which a plurality of image elements are arranged two-dimensionally to form an image element pattern is adhered to the other surface of the transparent material, the light collecting element pattern and the image element pattern are formed so that an array pitch of the light collecting elements and an array pitch of the image elements differ from each other, and the light collecting element pattern is formed such that an array pitch of adjacent light collecting elements changes gradually and continuously to make the enlarged virtual image of each image element appear on one side or the other side of the transparent element while gradually and continuously changing a height or a depth of the enlarged virtual image, which forms a three-dimensional enlarged virtual image group having a curved surface as a whole.

12. An ornamental display comprising:
a sheet-like or plate-like transparent material;
a light collecting element sheet adhered to one surface of the transparent material;
a plurality of convex lens-shaped light collecting elements arranged two-dimensionally on one surface of the light collecting element sheet to form a light collecting element pattern;
an image element sheet adhered to the other surface of the transparent material; and
a plurality of image elements are arranged two-dimensionally on one surface of the image element sheet to form an image element pattern,
wherein the light collecting element pattern and the image element pattern are formed so that an array pitch of the light collecting elements and an array pitch of the image elements differ from each other, whereby an enlarged virtual image of the image element appears on one side or the other side of the transparent material, and
wherein the light collecting element pattern is formed such that an array pitch of adjacent light collecting elements changes gradually and continuously to make the enlarged virtual image of each image element appear on one side or the other side of the transparent element while gradually and continuously changing a height or a depth of the enlarged virtual image, which forms a three-dimensional enlarged virtual image group having a curved surface as a whole.

13. A light collecting element sheet for use in the ornamental display as recited in claim 12, in which a plurality of convex lens-shaped light collecting elements are arranged two-dimensionally on one surface of the light collecting element sheet to form a light collecting element pattern, wherein
when a sheet or plate-like transparent material is adhered to the other surface of the light collecting element sheet, and an image element sheet in which a plurality of image elements are arranged two-dimensionally to form an image element pattern is adhered to an opposite surface side of the light collecting element sheet,
the light collecting element pattern and the image element pattern are formed so that an array pitch of the light collecting elements and an array pitch of the image elements differ from each other, and the light collecting element pattern is formed such that an array pitch of adjacent light collecting elements changes gradually and continuously to make the enlarged virtual image of each image element appear on one side or the other side of the transparent element while gradually and continuously changing a height or a depth of the enlarged virtual image, which forms a three-dimensional enlarged virtual image group having a curved surface as a whole.

14. An ornamental display comprising:
a first sheet or plate-like transparent material wherein;
a plurality of convex lens-shaped light collecting elements arranged two-dimensionally on one surface of the first transparent material to form a light collecting element pattern; and
a second sheet or plate-like transparent material and a plurality of image elements arranged two-dimensionally on one surface of the second transparent material to form an image element pattern,
wherein the first transparent material and the second transparent material are adhered to each other on the other surfaces thereof,
wherein the light collecting element pattern and the image element pattern are formed so that an array pitch of the light collecting elements and an array pitch of the image elements differ from each other, whereby an enlarged virtual image of the image element appears on one side or the other side of the transparent material, and
wherein the light collecting element pattern is formed such that an array pitch of adjacent light collecting elements changes gradually and continuously to make the enlarged virtual image of each image element appear on one side or the other side of the transparent element while gradually and continuously changing a height or a depth of the enlarged virtual image, which forms a three-dimensional enlarged virtual image group having a curved surface as a whole.

15. An ornamental display comprising:
a sheet or plate-like transparent material;
a plurality of convex lens-shaped light collecting elements arranged two-dimensionally on a part of one surface of the transparent material to form a light collecting element pattern; and
a plurality of image elements arranged two-dimensionally on the other part of the same front surface to form an image element pattern;
wherein the transparent material is folded between the light collecting element pattern and the image element pattern in a manner such that the light collecting element pattern and the image element pattern are positioned outside of the folded transparent material and the other surfaces of the transparent material facing each other are adhered,
wherein the light collecting element pattern and the image element pattern are formed so that an array pitch of the light collecting elements and an array pitch of the image elements differ from each other, and
wherein the light collecting element pattern is formed such that an array pitch of adjacent light collecting elements changes gradually and continuously to make the enlarged virtual image of each image element appear on one side or the other side of the transparent element while gradually and continuously changing a height or a depth of the enlarged virtual image, which forms a three-dimensional enlarged virtual image group having a curved surface as a whole.
